(19) United States
(12) Patent Application Publication
(10) Pub. No.: US 2023/0042363 A1
(43) Pub. Date: Feb. 9, 2023

(54) OPTICAL FIBER CONNECTOR AND FIBER LASER DEVICE

(71) Applicant: Fujikura Ltd., Tokyo (JP)

(72) Inventors: Kensuke Shima, Sakura-shi (JP); Rintaro Kitahara, Sakura-shi (JP)

(73) Assignee: Fujikura Ltd., Tokyo (JP)

(21) Appl. No.: 17/795,488

(22) PCT Filed: Feb. 16, 2021
(86) PCT No.: PCT/JP2021/005658

§ 371 Date: Jul. 26, 2022

(30) Foreign Application Priority Data
May 28, 2020 (JP) 2020-093230

(51) Int. Cl. H01S 3/067; H01S 3/091

(52) U.S. Cl. CPC H01S 3/0675; H01S 3/091

(57) ABSTRACT

An optical fiber connector includes: amplifying fibers in which an active element activated by excitation light is added to a core of each of the amplifying fibers. The amplifying fibers are connected together such that an absorption amount of excitation light per unit length increases with an increase of a distance from an incident end of the excitation light. A mode field diameter of laser light propagating through the core is same among the amplifying fibers.

### TECHNICAL FIELD

The present invention relates to an optical fiber connector and a fiber laser device.

Priority is claimed on Japanese Patent Application No. 2020-093230, filed May 28, 2020, the content of which is incorporated herein by reference.

### BACKGROUND

In recent years, fiber laser devices have been attracting attention in various fields such as processing, automobiles, and medical fields. The fiber laser device is characterized in that it is superior in beam quality and light collection property as compared with a conventional laser device (for example, a carbon dioxide laser device). Further, since the fiber laser device does not require spatial optical components, there are advantages such as no problem of alignment and no maintenance.

The following Patent Document 1 discloses a fiber laser device in the related art capable of improving the life of an amplifying fiber while reducing the size. Further, the following Patent Document 1 shows that when excitation light is incident from one end portion of the amplifying fiber, the amount of heat generated at one end is the largest, and the amount of generated heat is smaller as it approaches the other end of the amplifying fiber.

### PATENT LITERATURE

### Patent Document 1

Japanese Unexamined Patent Application, First Publication No. 2015-90909

By the way, the maximum output of a fiber laser device is limited by stimulated Raman scattering (SRS) that occurs non-linearly with respect to the laser output. As one of the methods for increasing the output of the fiber laser device while preventing the stimulated Raman scattering, there is a method of shortening the total length of the optical fiber.

However, depending on the length of the optical fiber (amplifying fiber) used for generating and amplifying laser light, a part of the excitation light is not absorbed by the amplifying fiber and passes through the amplifying fiber, so that the efficiency of the fiber laser device is reduced. In order to prevent such a reduction in efficiency, when a large number of active elements are added to the amplifying fiber to increase the absorption amount of excitation light per unit length, the heat generated by the amplifying fiber increases. Then, the amplifying fiber may be damaged or a Transverse Mode Instability: also referred to as Thermal Modal Instability (TMI) phenomenon may occur and the beam quality of the laser light may deteriorate.

### SUMMARY

One or more embodiments of the present invention provide an optical fiber connector and a fiber laser device capable of shortening the length of the amplifying fiber while reducing heat generated by the amplifying fiber.

The optical fiber connector according to one or more embodiments of the present invention is an optical fiber connector includes a plurality of amplifying fibers which are connected to each other and in which an active element activated by excitation light is added to cores, in which the plurality of amplifying fibers are connected to each other such that an absorption amount of excitation light per unit length increases, as a distance from an incident end of the excitation light increases, and mode field diameters of laser light propagating through the cores of the plurality of amplifying fibers are the same.

In the optical fiber connector according to one or more embodiments of the present invention, an amplifying fiber having a relatively small absorption amount of excitation light per unit length is disposed in a portion where the intensity of the excitation light is high, and an amplifying fiber having a relatively large absorption amount of excitation light per unit length is disposed in a portion where the intensity of the excitation light is low. Thus, heat generation can be reduced in the portion where the intensity of the excitation light is high, and the residual excitation light can be reduced by increasing the absorption amount of excitation light in the portion where the intensity of the excitation light is low. Further, in the optical fiber connector according to one or more embodiments of the present invention, the mode field diameters of the laser light propagating through the cores of the plurality of amplifying fibers are the same. This makes it possible to prevent deterioration of the beam quality of the laser light and loss of signal light (connection loss).

Further, in the optical fiber connector according to one or more embodiments of the present invention, the plurality of amplifying fibers may include a cladding that surrounds the core, and may be connected such that an amount of active elements per unit volume of a fiber composed of the core and the cladding increases sequentially, as the distance from the incident end of the excitation light increases.

Further, in the optical fiber connector according to one or more embodiments of the present invention, the plurality of amplifying fibers may be connected such that a concentration of active elements in the core gradually increases, as a distance from an incident end of the excitation light increases.

In the optical fiber connector according to one or more embodiments of the present invention, the plurality of amplifying fibers may be connected such that an addition area of active elements in the core increases sequentially, as a distance from an incident end of the excitation light increases.

Further, in the optical fiber connector according to one or more embodiments of the present invention, the cores of the plurality of amplifying fibers may have the same diameter.

Further, the optical fiber connector according to one or more embodiments of the present invention includes a first amplifying fiber and a second amplifying fiber, the excitation light is incident on one end of the first amplifying fiber, an absorption amount of excitation light per unit length of the first amplifying fiber is set to a first absorption amount, one end of the second amplifying fiber is connected to the other end of the first amplifying fiber, and an absorption amount of excitation light per unit length of the second amplifying fiber is set to a second absorption amount larger than the first absorption amount.

Further, in the optical fiber connector according to one or more embodiments of the present invention, the plurality of amplifying fibers may further include a third amplifying fiber, one end of the third amplifying fiber may be connected to the other end of the second amplifying fiber, and an absorption amount of excitation light per unit length of the third amplifying fiber may be set to a third absorption amount larger than the second absorption amount.

In the optical fiber connector according to one or more embodiments of the present invention, the plurality of amplifying fibers may further include a fourth amplifying fiber. One end of the fourth amplifying fiber may be connected to the other end of the second amplifying fiber, an absorption amount of excitation light per unit length of the fourth amplifying fiber may be set to a fourth absorption amount smaller than the second absorption amount, and the excitation light may be incident on the other end of the fourth amplifying fiber.

In the optical fiber connector according to one or more embodiments of the present invention, the fourth absorption amount may be larger than the first absorption amount.

A fiber laser device according to one or more embodiments of the present invention includes an excitation light source configured to output excitation light; the optical fiber connector according to one or more embodiments; a combiner configured to couple the excitation light output from the excitation light source to the optical fiber connector; and an output end configured to output light amplified by the optical fiber connector to an outside.

Further, in the fiber laser device according to one or more embodiments of the present invention, FBG-formed resonator fibers may be connected to both ends of the optical fiber connector, and the combiner may couple excitation light output from the excitation light source to the optical fiber connector via any one of the resonator fibers.

A fiber laser device according to one or more embodiments of the present invention includes a first excitation light source configured to output excitation light; a second excitation light source configured to output excitation light; the optical fiber connector according to one or more embodiments; FBG-formed resonator fibers connected to both ends of the optical fiber connector; a first combiner configured to couple the excitation light output from the first excitation light source to the optical fiber connector via any one of the resonator fibers; a second combiner configured to couple the excitation light output from the second excitation light source to the optical fiber connector via any one of the other resonator fibers; and an output end configured to output light amplified by the optical fiber connector to an outside.

According to the present invention, it is possible to obtain the advantageous effect that the length of the amplifying fiber can be shortened while reducing the heat generated by the amplifying fiber.

### BRIEF DESCRIPTION OF THE DRAWINGS

FIG. 1 is a diagram showing a main configuration of a fiber laser device according to first embodiments of the present invention.

FIG. 2A is a cross-sectional view showing a specific configuration example of an amplifying fiber in the first embodiments of the present invention.

FIG. 2B is a cross-sectional view showing a specific configuration example of the amplifying fiber in the first embodiments of the present invention.

FIG. 3 is a diagram showing a main configuration of a fiber laser device according to second embodiments of the present invention.

FIG. 4 is a diagram showing a main configuration of a fiber laser device according to third embodiments of the present invention.

FIG. 5A is a diagram showing an analysis result of an optical fiber connector according to the first embodiments of the present invention.

FIG. 5B is a diagram showing an analysis result of the optical fiber connector according to the first embodiments of the present invention.

FIG. 6A is a diagram showing an analysis result of an optical fiber connector according to the second embodiments of the present invention.

FIG. 6B is a diagram showing an analysis result of the optical fiber connector according to the second embodiments of the present invention.

FIG. 7A is a diagram showing an analysis result of an optical fiber connector in Comparative Example 1.

FIG. 7B is a diagram showing an analysis result of the optical fiber connector in Comparative Example 1.

FIG. 8A is a diagram showing an analysis result of an optical fiber connector in Comparative Example 2.

FIG. 8B is a diagram showing an analysis result of the optical fiber connector in Comparative Example 2.

### DETAILED DESCRIPTION

Hereinafter, an optical fiber connector and a fiber laser device according to embodiments of the present invention will be described in detail with reference to the drawings. In addition, in the drawings used in the following description, in order to make the features easy to understand, for convenience, the characteristic part may be enlarged and shown, and the dimensional ratio of each component is not always the same as the actual one. Further, the present invention is not limited to the embodiments below.

### First Embodiments

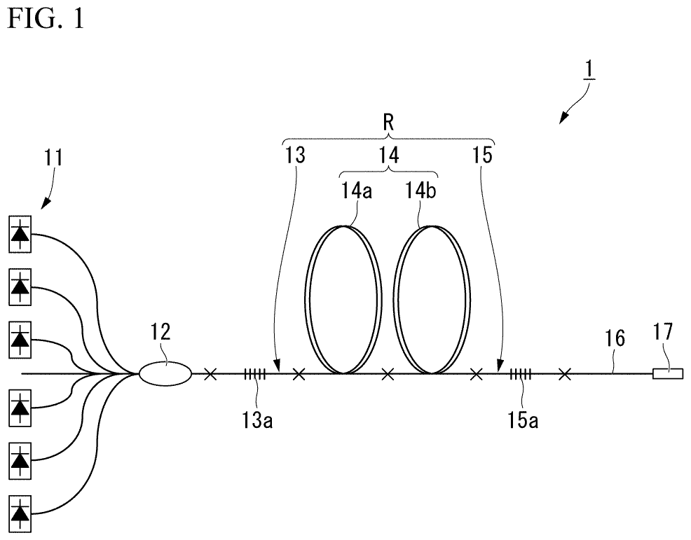

FIG. 1 is a diagram showing a main configuration of a fiber laser device according to first embodiments of the present invention. As shown in FIG. 1, a fiber laser device 1 of the present embodiments includes excitation light sources 11, a combiner 12, a resonator fiber 13, an optical fiber connector 14, a resonator fiber 15, a delivery fiber 16, and an output end 17. Such a fiber laser device 1 is a so-called forward excitation-type fiber laser device.

Here, the resonator fiber 13, the optical fiber connector 14, and the resonator fiber 15 configure a resonator R. The resonator R generates signal light, which is laser light, by the excitation light output by the excitation light sources 11. In the present specification, the excitation light source 11 side may be referred to as “front” and the output end 17 side may be referred to as “rear” when viewed from the optical fiber connector 14.

Further, in FIG. 1, fusion splicing portions of various fibers are indicated by x marks. The fusion splicing portions are actually disposed and protected inside the reinforcing portions (not shown). The reinforcing portions include, for example, a fiber accommodating body having a groove capable of accommodating an optical fiber, and a resin for fixing various fibers to the fiber accommodating body in a state where the fusion splicing portion is accommodated in the groove of the fiber accommodating body. Even in the drawings other than FIG. 1, the fusion splicing portions of various fibers are indicated by x.

The excitation light source 11 outputs the excitation light (forward excitation light). The number of the excitation light sources 11 may be any number depending on the power of the laser light output from the output end 17 of the fiber laser device 1. As the excitation light source 11, for example, a laser diode can be used. The combiner 12 couples the excitation light output by each of the excitation light sources 11 to the front end portion of the resonator R (the front end portion of the resonator fiber 13).

The front end portion of the resonator fiber 13 is fused to the combiner 12, and the rear end portion of the resonator fiber 13 is fused to the front end portion of the optical fiber connector 14 (the front end portion of the amplifying fiber 14a). A High Reflectivity-Fiber Bragg Grating (HR-FBG) 13a is formed in the core of the resonator fiber 13. The HR-FBG 13a is adjusted to reflect light having a wavelength of signal light with a reflectance of almost 100%, among the light emitted by the active element of the optical fiber connector 14 in the excited state. The HR-FBG 13a is a structure in which a portion having a high refractive index is repeated at a constant period along the longitudinal direction thereof.

The optical fiber connector 14 is configured by connecting the amplifying fiber 14a (first amplifying fiber) and the amplifying fiber 14b (second amplifying fiber). The amplifying fibers 14a and 14b have a core to which one or more types of active elements are added, a first cladding covering the core, a second cladding covering the first cladding, and a protective coating covering the second cladding. That is, the amplifying fibers 14a and 14b are double cladding fibers. As the active element added to the core, for example, a rare earth element such as erbium (Er), ytterbium (Yb), or neodymium (Nd) is used. These active elements emit light in the excited state.

Silica glass or the like can be used as the core and the first cladding. As the second cladding, a resin such as a polymer can be used. As the protective coating, a resin material such as an acrylic resin or a silicone resin can be used. The amplifying fibers 14a and 14b are multi-mode fibers.

The amplifying fiber 14a and the amplifying fiber 14b are configured such that the mode field diameter of the signal light propagating through the core of the amplifying fiber 14a and the mode field diameter of the signal light propagating through the core of the amplifying fiber 14b are the same. Here, the mode field diameter is generally an index showing the spread of the optical power distribution of the signal light propagating in the core of the optical fiber in the cross-sectional direction of the optical fiber, and shows how much the signal light leaks from the core to the cladding side and propagates. Further, in the present specification, “the mode field diameters are the same” means that the width of the secondary moment (D4σ) of the fundamental mode propagating through the core is within ±10%.

For example, the amplifying fibers 14a and 14b have the same refractive index structure in order to make the mode field diameters of the signal light propagating in the core the same. That is, the diameter and material of the core of the amplifying fiber 14a are the same as the diameter and material of the core of the amplifying fiber 14b, the diameter and material of the first cladding of the amplifying fiber 14a are the same as the diameter and material of the first cladding of the amplifying fiber 14b, and the diameter and material of the second cladding of the amplifying fiber 14a are the same as the diameter and material of the second cladding of the amplifying fiber 14b. As long as the mode field diameters of the signal light propagating through the core are the same, the refractive index structures of the amplifying fibers 14a and 14b do not necessarily have to be the same, and different refractive index structures may be used.

Further, the amplifying fibers 14a and 14b are configured to have different amounts of absorbed excitation light per unit length. Specifically, the absorption amount of excitation light per unit length of the amplifying fiber 14b (second absorption amount) is configured to be larger than the absorption amount of excitation light per unit length of the amplifying fiber 14a (first absorption amount). That is, the amplifying fibers 14a and 14b are connected to each other such that the absorption amount of the excitation light per unit length increases as the distance from the incident end of the excitation light (the front end portion of the amplifying fiber 14a) increases. With this configuration, the length of the optical fiber connector 14 (amplifying fibers 14a, 14b) can be shortened while reducing the heat generated by the optical fiber connector 14 (amplifying fibers 14a, 14b).

Here, the absorption amount of excitation light per unit length is determined depending on the amount of active element per unit volume of the fiber (including the core and cladding) composed of the core and the claddings (the first cladding and the second cladding). Therefore, the amount of the active element per unit volume of a fiber composed of the core and the claddings of the amplifying fiber 14b is larger than the amount of the active element per unit volume of the fiber composed of the core and the claddings of the amplifying fiber 14a.

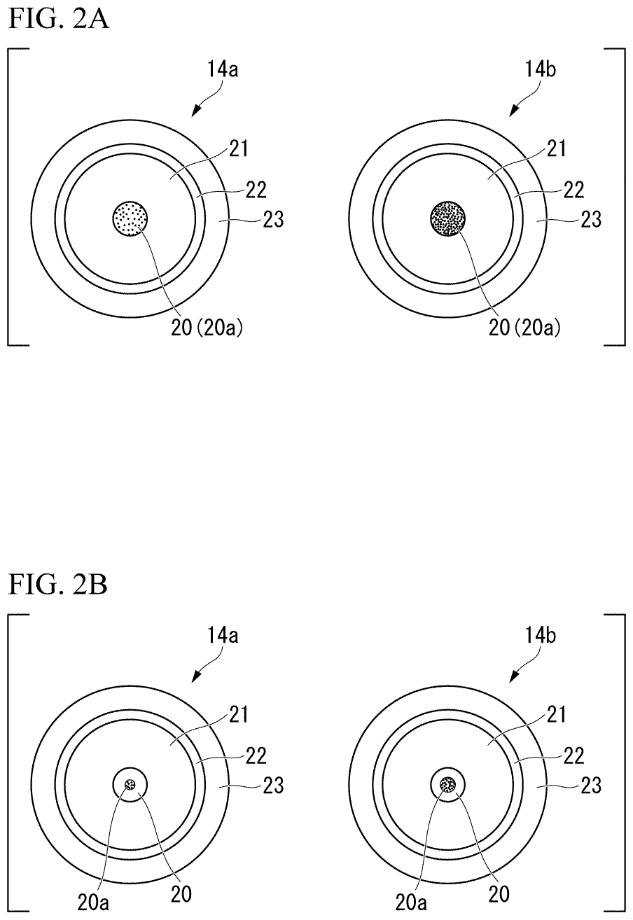

FIGS. 2A and 2B are cross-sectional views showing specific configuration examples of the amplifying fiber in the first embodiments of the present invention. As shown in FIGS. 2A and 2B, the amplifying fibers 14a and 14b have substantially the same configuration, and include a core 20, a first cladding 21, a second cladding 22, and a protective coating 23. In FIGS. 2A and 2B, the region designated by the reference numeral 20a indicates a region in the core 20 to which the active element is added (hereinafter, referred to as “addition region 20a”).

In the example shown in FIG. 2A, the active element is added to the entire core 20 for each of the amplifying fibers 14a and 14b. That is, for each of the amplifying fibers 14a and 14b, the addition region 20a occupies the entire core 20. However, the concentration of the active element in the core 20 in the amplifying fiber 14b (concentration of the active element in the addition region 20a) is higher than the concentration of the active element in the core 20 in the amplifying fiber 14a. As described above, in the example shown in FIG. 2A, the absorption amount of the excitation light per unit length is changed by changing the concentration of the active element to be added to the entire core 20.

In the example shown in FIG. 2B, the mass percent concentration [wt %] of the active element in the addition region 20a in the core 20 is the same for each of the amplifying fibers 14a and 14b. That is, the concentration of the active element in the addition region 20a is the same for each of the amplifying fibers 14a and 14b. However, the addition area of the active element in the core 20 of the amplifying fiber 14b (the area of the addition region 20a) is larger than the addition area of the active element in the core 20 of the amplifying fiber 14a.

As described above, in the example shown in FIG. 2B, the absorption amount of the excitation light per unit length is changed by changing the addition area of the active element in the core 20. Therefore, even when the diameters of the cores 20 of the amplifying fibers 14a and 14b are the same and the active elements having the same concentration are added, the absorption amount of excitation light per unit length can be changed by changing the addition area of the active elements in the core 20. In the example shown in FIG. 2B, the refractive index of the addition region 20a in the core 20 and the refractive index of the other regions (non-addition regions to which the active element is not added) may be the same.

The front end portion of the resonator fiber 15 is fused to the rear end portion of the optical fiber connector 14 (the rear end portion of an amplifying fiber 14b), and the rear end portion of the resonator fiber 15 is fused to the front end portion of the delivery fiber 16. An Output Coupler-Fiber Bragg Grating (OC-FBG) 15a is formed in the core of the resonator fiber 15. The OC-FBG 15a has almost the same structure as the HR-FBG 13a, but is adjusted to reflect light with a lower reflectance than the HR-FBG 13a. For example, the OC-FBG 15a is adjusted such that the reflectance of the light having a wavelength of signal light is about 10 to 20%.

In the optical fiber connector 14 (amplifying fibers 14a, 14b), the signal light reflected by the HR-FBG 13a and OC-FBG 15a reciprocates in the longitudinal direction of the optical fiber connector 14 (amplifying fibers 14a, 14b). The signal light is amplified along with this reciprocation to become laser light. In this way, in the resonator R, the light is amplified and signal light (laser light) is generated.

The delivery fiber 16 transmits the laser light generated in the resonator R. The delivery fiber 16 includes a core, a cladding surrounding the core, and a coating covering the cladding. As the delivery fiber 16, for example, a multi-mode fiber can be used.

The output end 17 is connected to the rear end portion of the delivery fiber 16, and emits the laser light transmitted by the delivery fiber 16. The output end 17 includes a columnar body (light transmitting columnar member) that transmits the laser light transmitted by the delivery fiber 16. This member is a so-called end cap.

Next, the amount of residual excitation light and the amount of heat generated by the optical fiber connector 14 (the amplifying fiber 14a and the amplifying fiber 14b) will be examined. It is assumed that the wavelength of the excitation light incident on the optical fiber connector 14 is λp [nm], the power is Pin [W], and the absorption amount of the excitation light per unit length of the optical fiber connector 14 is a [dB/m]. With respect to the absorption amount a, the absorption amount a1 [dB/m] of the excitation light per unit length of the amplifying fiber 14a, or the absorption amount a2 [dB/m] of the excitation light per unit length of the amplifying fiber 14b can be obtained.

It is assumed that z is the position in the length direction of the optical fiber connector 14 when the front end portion of the optical fiber connector 14 (the front end portion of the amplifying fiber 14a) is the origin. The power Pp(z) [W] of the excitation light in the optical fiber connector 14 is expressed by the following Expression (1).

$${P}_{p} ( z ) \approx {P}_{i n} \cdot {10}^{- \frac{az}{10}} \qquad ( 1 )$$

Assuming that the length of the optical fiber connector 14 is L, the residual excitation light at z=L is represented by the following Expression (2). From the following Expression (2), it can be seen that as the length L of the optical fiber connector 14 becomes longer, the excitation light is absorbed by the optical fiber connector 14, but as the length L of the optical fiber connector 14 becomes shorter, the excitation light is not absorbed by the optical fiber connector 14.

$${P}_{p} ( L ) \approx {P}_{i n} \cdot {10}^{- \frac{a L}{10}} \qquad ( 2 )$$

Further, assuming that the wavelength of the signal light is λs, the amount Q [W/m] of generated heat per unit length of the optical fiber connector 14 is expressed by the following Expression (3).

$$Q = \frac{ln ( 10 )}{10} ( 1 - \frac{{λ}_{p}}{{λ}_{s}} ) a {P}_{p} ( z ) \qquad ( 3 )$$

According to the above Expression (3), the amount Q of generated heat of the optical fiber connector 14 is the largest at the front end portion (z=0) of the optical fiber connector 14, and the maximum value Qmax [W/m] is expressed by the following Expression (4).

$${Q}_{max} = \frac{ln ( 10 )}{10} ( 1 - \frac{{λ}_{p}}{{λ}_{s}} ) a {P}_{i n} \qquad ( 4 )$$

Therefore, when the absorption amount a of the excitation light per unit length of the optical fiber connector 14 is increased by increasing the amount of active element in the core of the optical fiber connector 14, it can be seen that the amount Q of generated heat per unit length increases. On the contrary, when the absorption amount a of the excitation light per unit length of the optical fiber connector 14 is reduced by reducing the amount of active element in the core of the optical fiber connector 14, it can be seen that the amount Q of generated heat per unit length is reduced.

In the present embodiments, the amplifying fiber 14a having a relatively small absorption amount of the excitation light per unit length is disposed in a portion where the intensity of the excitation light is high, and the amplifying fiber 14b having a relatively large absorption amount of the excitation light per unit length is disposed in a portion where the intensity of the excitation light is low. Thus, heat generation can be reduced on the front end portion side of the optical fiber connector 14 having a high excitation light intensity, and the residual excitation light can be reduced by increasing the absorption amount of excitation light on the rear end portion side of the optical fiber connector 14 having a low excitation light intensity.

As described above, in the present embodiments, the amplifying fiber 14a having a relatively small absorption amount of the excitation light per unit length and the amplifying fiber 14b having a relatively large absorption amount of the excitation light per unit length configure the optical fiber connector 14 that forms a part of the resonator R. Then, the excitation light is incident from the front end portion of the amplifying fiber 14a having a relatively small absorption amount of the excitation light per unit length.

Thus, heat generation can be reduced because the absorption amount of the excitation light is small on the front end portion side (the side where the amplifying fiber 14a is disposed) of the optical fiber connector 14 having a high intensity of the excitation light. Further, the absorption amount of excitation light can be increased to reduce the residual excitation light on the rear end portion side (the side where the amplifying fiber 14b is disposed) of the optical fiber connector 14 having a low excitation light intensity. As a result, the length of the optical fiber connector 14 (amplifying fibers 14a, 14b) can be shortened while reducing the heat generated by the optical fiber connector 14 (amplifying fibers 14a, 14b).

Further, in the present embodiments, the mode field diameter of the signal light propagating through the core of the amplifying fiber 14a and the mode field diameter of the signal light propagating through the core of the amplifying fiber 14b are the same. Thus, it is possible to prevent the deterioration of the beam quality of the signal light propagating through the cores of the amplifying fibers 14a and 14b and the occurrence of the signal light loss (connection loss).

### Second Embodiments

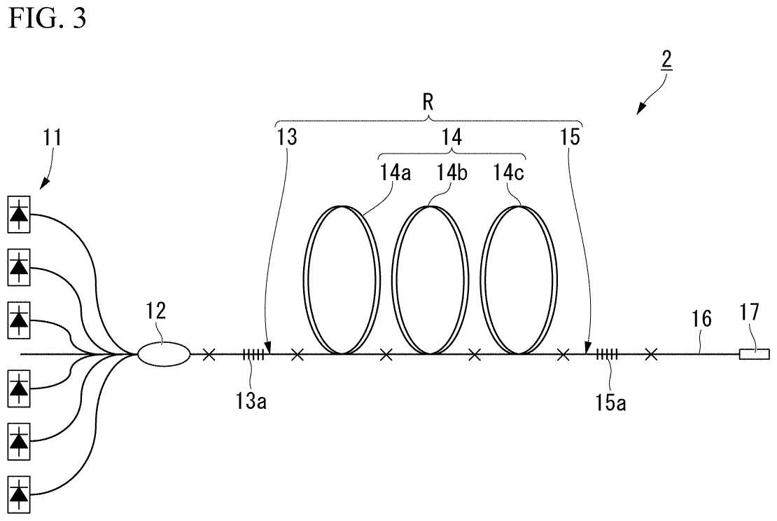

FIG. 3 is a diagram showing a main configuration of a fiber laser device according to second embodiments of the present invention. In FIG. 3, the same reference numerals are given to the components similar to those shown in FIG. 1. The fiber laser device 2 of the present embodiments is different from the fiber laser device 1 shown in FIG. 1 in that the optical fiber connector 14 includes an amplifying fiber 14c (third amplifying fiber) in addition to the amplifying fibers 14a and 14b.

The amplifying fiber 14c is the same as the amplifying fibers 14a and 14b. The amplifying fiber 14c is a double cladding fiber including a core to which one or more types of active elements are added, a first cladding covering the core, a second cladding covering the first cladding, and a protective coating covering the second cladding. As the active element added to the core, for example, a rare earth element such as erbium (Er), ytterbium (Yb), or neodymium (Nd) is used.

The materials of the core, the first cladding, the second cladding, and the protective coating of the amplifying fiber 14c are the same as the materials of the amplifying fibers 14a and 14b. The amplifying fiber 14c is a multi-mode fiber like the amplifying fibers 14a and 14b.

Similar to the amplifying fibers 14a and 14b, the amplifying fiber 14c is configured such that the mode field diameter of the signal light propagating through the cores of the amplifying fibers 14a and 14b and the mode field diameter of the signal light propagating through the core of the amplifying fiber 14c are the same. Further, the absorption amount of excitation light per unit length of the amplifying fiber 14c (third absorption amount) is set to be larger than the absorption amount of excitation light per unit length of the amplifying fiber 14b (second absorption amount). That is, the amplifying fibers 14a, 14b, and 14c are connected to each other such that the absorption amount of the excitation light per unit length increases as the distance from the incident end of the excitation light (the front end portion of the amplifying fiber 14a) increases.

The method of adding the active element to the core of the amplifying fiber 14c may be either the method shown in FIG. 2A or the method shown in FIG. 2B. As shown in FIG. 2A, in the method of adding the active element to the entire core 20, the concentration of the active element in the core of the amplifying fiber 14c may be higher than the concentration of the active element in the core of the amplifying fiber 14b. As shown in FIG. 2B, by the method of making the concentration of the active element in the addition region 20a the same, the addition area of the core 20 of the amplifying fiber 14c may be larger than the addition area of the core 20 of the amplifying fiber 14b.

As described above, in the present embodiments, the amplifying fiber 14a, the amplifying fiber 14b having a larger absorption amount of the excitation light per unit length than the absorption amount of the amplifying fiber 14a, and the amplifying fiber 14c having a larger absorption amount of the excitation light per unit length than the absorption amount of the amplifying fiber 14b configure the optical fiber connector 14 that forms a part of the resonator R. Then, the excitation light is incident from the front end portion of the amplifying fiber 14a. Thus, the length of the optical fiber connector 14 (amplifying fibers 14a, 14b, and 14c) can be shortened while reducing the heat generated by the optical fiber connector 14 (amplifying fibers 14a, 14b, and 14c) as in the first embodiments.

Further, in the present embodiments, the amplifying fiber 14a, the amplifying fiber 14b, and the amplifying fiber 14c are configured such that the mode field diameter of the signal light propagating through the core of the amplifying fiber 14a, the mode field diameter of the signal light propagating through the core of the amplifying fiber 14b, and the mode field diameter of the signal light propagating through the core of the amplifying fiber 14c are the same. Then, as in the first embodiments, even in the present embodiments, it is possible to prevent the deterioration of the beam quality of the signal light propagating through the cores of the amplifying fibers 14a, 14b, and 14c and the occurrence of the signal light loss (connection loss).

### Third Embodiments

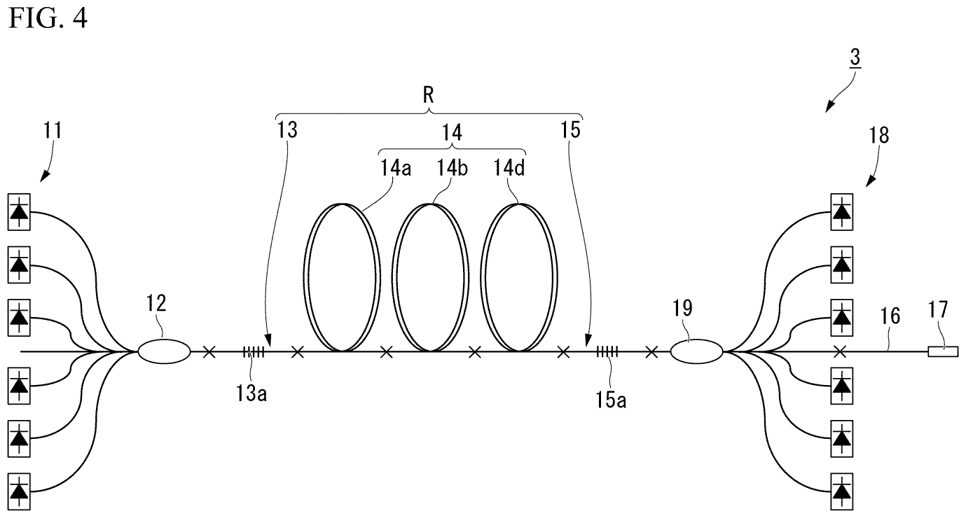

FIG. 4 is a diagram showing a main configuration of a fiber laser device according to third embodiments of the present invention. In FIG. 4, the same reference numerals are given to the components similar to those shown in FIG. 1. The fiber laser device 3 of the present embodiments is different from the fiber laser device 1 shown in FIG. 1 in that an excitation light source 18 (second excitation light source) and a combiner 19 (second combiner) are provided, and the optical fiber connector 14 includes an amplifying fiber 14d (fourth amplifying fiber) in addition to the amplifying fibers 14a and 14b. Such a fiber laser device 3 is a so-called bidirectional excitation-type fiber laser device.

The excitation light sources 18 output excitation light (backward excitation light). The number of the excitation light sources 18 is any number depending on the power of the laser light output from the output end 17 of the fiber laser device 3. As the excitation light source 18, for example, a laser diode can be used, like the excitation light source 11 (first excitation light source). The combiner 19 couples the excitation light output by each of the excitation light sources 18 to the rear end portion of the resonator R (the rear end portion of the resonator fiber 15). The configuration of the combiner 19 is the same as that of the combiner 12 (first combiner).

The amplifying fiber 14d is the same as the amplifying fibers 14a and 14b. The amplifying fiber 14d is a double cladding fiber including a core to which one or more types of active elements are added, a first cladding covering the core, a second cladding covering the first cladding, and a protective coating covering the second cladding. As the active element added to the core, for example, a rare earth element such as erbium (Er), ytterbium (Yb), or neodymium (Nd) is used.

The materials of the core, the first cladding, the second cladding, and the protective coating of the amplifying fiber 14d are the same as the materials of the amplifying fibers 14a and 14b. The amplifying fiber 14d is a multi-mode fiber like the amplifying fibers 14a and 14b.

The mode field diameter of the signal light propagating through the cores of the amplifying fibers 14a and 14b and the mode field diameter of the signal light propagating through the core of the amplifying fiber 14d are configured to be the same. Further, in the amplifying fiber 14d, the absorption amount of excitation light per unit length of the amplifying fiber 14d (fourth absorption amount) is set to be smaller than the absorption amount of excitation light per unit length of the amplifying fiber 14b (second absorption amount).

Further, when the amount of locally generated heat of each of the amplifying fibers 14a, 14b, and 14d is within the permissible range of temperature rise, and the total length of the amplifying fibers 14a, 14b, and 14d is within the permissible range for the occurrence of stimulated Raman scattering, it is not necessary to be same at the front end of the fiber 14a, the front end of the fiber 14b, the rear end of the fiber 14b, and the rear end of the fiber 14d. For example, when the amount of generated heat per unit length is the same, TMI is less likely to occur as the light intensity of the laser light that is guided by the core is stronger. Therefore, the closer to the rear end of the laser resonator, the larger the allowable amount of generated heat. Therefore, for example, when the outputs of the front excitation light source 11 and the rear excitation light source 18 are substantially the same in FIG. 4, the absorption amount of excitation light per unit length of the amplifying fiber 14d (fourth absorption amount) may be larger than the absorption amount of excitation light per unit length of the amplifying fiber 14a (first absorption amount).

That is, in the present embodiments, when the amplifying fibers 14a and 14b are regarded as one unit and the amplifying fibers 14b and 14d are regarded as another unit, the amplifying fiber of each unit is connected such that an absorption amount of excitation light per unit length increases, as a distance from an incident end of the excitation light increases. That is, the amplifying fibers 14a and 14b are connected to each other such that the absorption amount of the excitation light per unit length increases as the distance from the incident end of the excitation light (the front end portion of the amplifying fiber 14a) increases. Further, the amplifying fibers 14b and 14d are connected to each other such that the absorption amount of the excitation light per unit length increases, as the distance from the incident end of the excitation light (the rear end portion of the amplifying fiber 14d) increases.

The method of adding the active element to the core of the amplifying fiber 14d may be either the method shown in FIG. 2A or the method shown in FIG. 2B. As shown in FIG. 2A, in the method of adding the active element to the entire core 20, the concentration of the active element in the core of the amplifying fiber 14d may be lower than the concentration of the active element in the core of the amplifying fiber 14b. As shown in FIG. 2B, by the method of making the concentration of the active element in the addition region 20a the same, the addition area of the core 20 of the amplifying fiber 14d may be smaller than the addition area of the core 20 of the amplifying fiber 14b.

As described above, in the present embodiments, the amplifying fiber 14a, the amplifying fiber 14b having a larger absorption amount of the excitation light per unit length than the absorption amount of the amplifying fiber 14a, and the amplifying fiber 14d having a smaller absorption amount of the excitation light per unit length than the absorption amount of the amplifying fiber 14b configure the optical fiber connector 14 that forms a part of the resonator R. Then, the excitation light is incident from the front end portion of the amplifying fiber 14a and the rear end portion of the amplifying fiber 14d. Thus, the length of the optical fiber connector 14 (amplifying fibers 14a, 14b, and 14d) can be shortened while reducing the heat generated by the optical fiber connector 14 (amplifying fibers 14a, 14b, and 14d) as in the first embodiments.

Further, in the present embodiments, the amplifying fibers 14a, 14b, and 14d have the same mode field diameter of the signal light propagating through the core. Then, as in the first embodiments, even in the present embodiments, it is possible to prevent the deterioration of the beam quality of the signal light propagating through the cores of the amplifying fibers 14a, 14b, and 14d and the occurrence of the signal light loss (connection loss).

Further, since the fourth absorption amount is larger than the first absorption amount, it is possible to absorb the excitation light with a short fiber length by using the amplifying fiber 14d having a larger absorption amount than the amplifying fiber 14a. Therefore, it is possible to prevent stimulated Raman scattering while preventing TMI.

### Analysis Result

The inventors of the present application have analyzed the residual excitation light amount and the amount of generated heat of the optical fiber connector 14 in the fiber laser device 1 of the first embodiments and the fiber laser device 2 of the second embodiments. In performing the analyses, the wavelength of the excitation light was set to 976 [nm], and the wavelength of the signal light was set to 1070 [nm]. Further, the reflectance of the HR-FBG 13a in the resonator fiber 13 with respect to the signal light was set to 99%, and the reflectance of the OC-FBG 15a in the resonator fiber 15 with respect to the signal light was set to 10%.

Ytterbium is added to the cores of the amplifying fibers 14a and 14b of the optical fiber connector 14 included in the fiber laser device 1 of the first embodiments. The absorption amount of excitation light per unit length of the amplifying fiber 14a was set to 0.85 [dB/m], and the length was set to 5 [m]. Further, the absorption amount of excitation light per unit length of the amplifying fiber 14b was set to 2.25 [dB/m], and the length was set to 7 [m]. The absorption amount of excitation light by such an optical fiber connector 14 is 0.85 [dB/m]×5 [m]+2.25 [dB/m]×7 [m]=20 [dB] (that is, 99%).

Ytterbium is added to the cores of the amplifying fibers 14a, 14b, and 14c of the optical fiber connector 14 included in the fiber laser device 2 of the second embodiments. The absorption amount of excitation light per unit length of the amplifying fiber 14a was set to 0.85 [dB/m], and the length was set to 3 [m]. Further, the absorption amount of excitation light per unit length of the amplifying fiber 14b was set to 1.5 [dB/m], and the length was set to 3 [m]. Further, the absorption amount of excitation light per unit length of the amplifying fiber 14c was set to 4.3 [dB/m], and the length was set to 3 [m]. The absorption amount of excitation light by such an optical fiber connector 14 is (0.85 [dB/m]+1.5 [dB/m]+4.3 [dB/m])×3 [m]=19.95 [dB] (that is, approximately 99%).

Further, the optical fiber connector 14 provided in the fiber laser devices 1 and 2 was prepared as Comparative Examples 1 and 2 in place of one amplifying fiber. The amplifying fiber in Comparative Example 1 has an absorption amount of excitation light per unit length of 1.0 [dB/m] and a length of 20 [m]. The amplifying fiber in Comparative Example 2 has an absorption amount of excitation light per unit length of 1.667 [dB/m] and a length of 12 [m]. That is, in Comparative Example 2, in order to prevent stimulated Raman scattering, the length of the amplifying fiber is shorter than that of Comparative Example 1, and the absorption amount of excitation light per unit length is large.

The absorption amount of the excitation light per unit length of the amplifying fiber in the second comparative example is 5/3 times the absorption amount of the excitation light per unit length of the amplifying fiber in the first comparative example. The absorption amount of the excitation light of the amplifying fiber in Comparative Example 1 is 1.0 [dB/m]×20 [m]=20 [dB] (that is, 99%). The absorption amount of the excitation light of the amplifying fiber in Comparative Example 2 is 1.66 [dB/m]×12 [m]=19.92 [dB] (that is, approximately 99%).

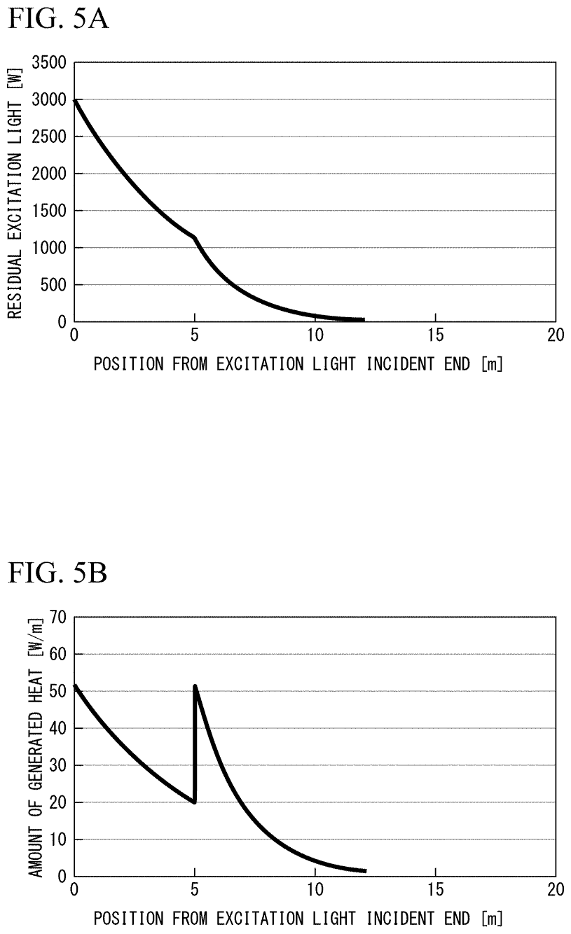

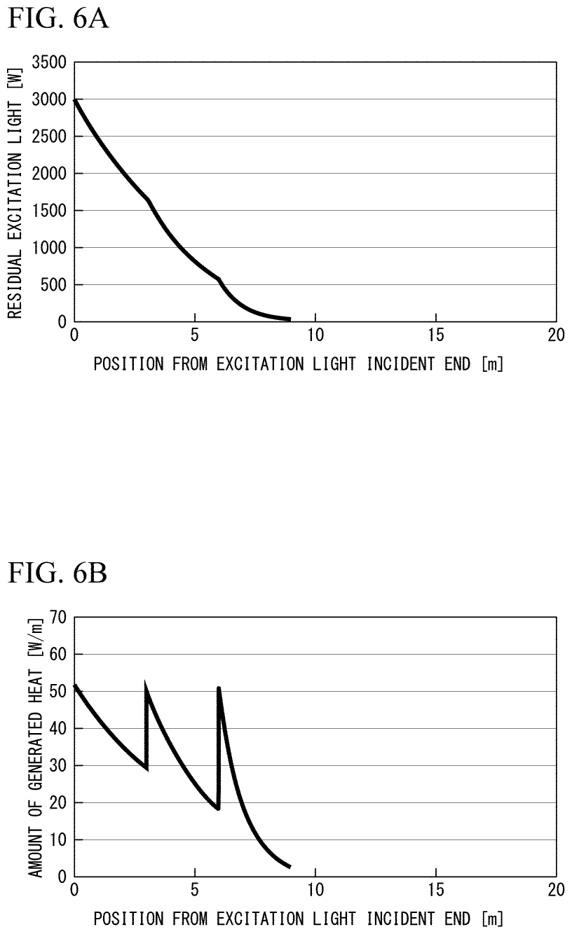

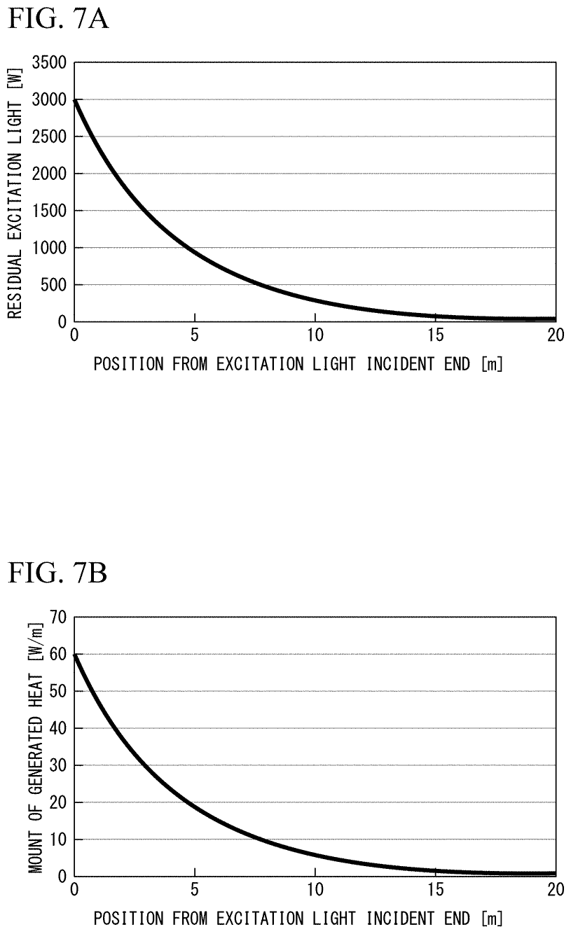

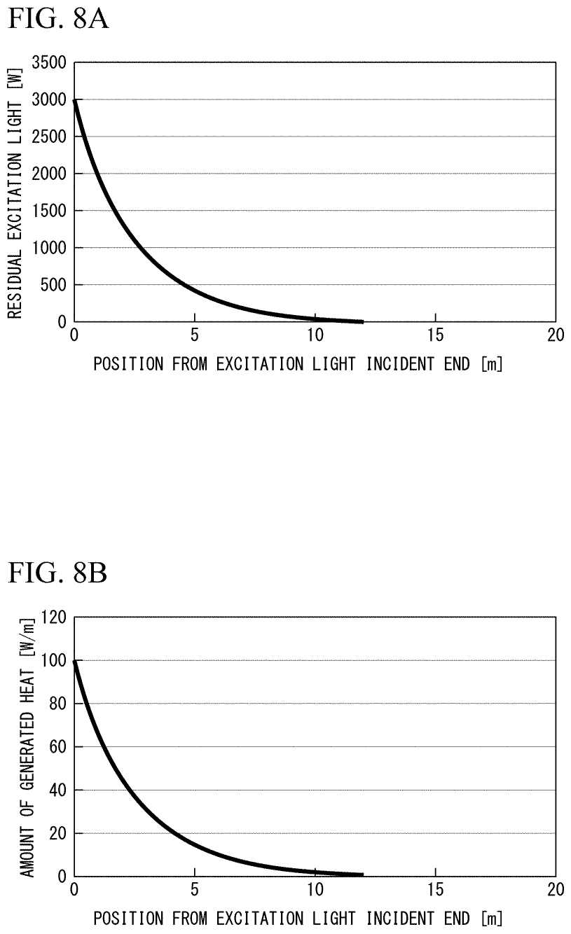

FIGS. 5A and 5B are diagrams showing analysis results of the optical fiber connector according to the first embodiments of the present invention. FIGS. 6A and 6B are diagrams showing analysis results of the optical fiber connector according to the second embodiments of the present invention. FIGS. 7A and 7B are diagrams showing analysis results of the optical fiber connector according to Comparative Example 1. FIGS. 8A and 8B are diagrams showing analysis results of the optical fiber connector according to Comparative Example 2. FIGS. 5A, 6A, 7A, and 8A are diagrams showing residual excitation light in the longitudinal direction of the optical fiber connector (amplifying fiber), and FIGS. 5B, 6B, 7B, and 8B are diagrams showing the amount of generated heat in the longitudinal direction of an optical fiber connector (amplifying fiber).

In the analyses, the power of the excitation light incident on the front end portion of the optical fiber connector 14 in the first and second embodiments was set to 3000 [W]. The power of the excitation light incident on the front end portion of the amplifying fiber in Comparative Examples 1 and 2 was also set to 3000 [W].

First, Comparative Example 1 will be examined. Referring to FIG. 7A, it can be seen that the residual excitation light in the amplifying fiber gradually decreases as the position from the excitation light incident end becomes farther, and the residual excitation light is 1% or less at the position of the other end of the amplifying fiber (20 [m]). Further, referring to FIG. 7B, the maximum value of the amount of generated heat per unit length of the amplifying fiber in Comparative Example 1 is about 61 [W/m]. Here, a case is considered where the length of the amplifying fiber is set to 12 [m] in order to prevent stimulated Raman scattering. Since the residual excitation light in the amplifying fiber in this case is 189 [W] with reference to FIG. 7A, it can be seen that the utilization rate of the excitation light remains at 94%.

Next, Comparative Example 2 will be examined. Referring to FIG. 8A, it can be seen that the residual excitation light in the amplifying fiber gradually decreases as the position from the excitation light incident end becomes farther, and the residual excitation light is 1% or less at the position of the other end of the amplifying fiber (12 [m]). However, referring to FIG. 8B, the maximum value of the amount of generated heat per unit length of the amplifying fiber in Comparative Example 2 increases to about 100 [W/m].

Next, the first embodiments will be examined. With reference to FIG. 5A, it can be seen that the residual excitation light in the optical fiber connector 14 is 1% or less at the position (12 [m]) at the other end of the amplifying fiber. Further, referring to FIG. 5B, it can be seen that the maximum value of the amount of generated heat per unit length of the optical fiber connector 14 in the first embodiments is reduced to about 50 [W/m].

Subsequently, the second embodiments will be examined. With reference to FIG. 6A, it can be seen that the residual excitation light in the optical fiber connector 14 is 1% or less at the position (9 [m]) at the other end of the amplifying fiber. That is, it can be seen that 99% of the excitation light is absorbed by using a length (9 [m]) shorter than the length (12 [m]) of the optical fiber connector 14 of the first embodiments. Further, referring to FIG. 6B, it can be seen that the maximum value of the amount of generated heat per unit length of the optical fiber connector 14 in the second embodiments is reduced to about 50 [W/m] as in the first embodiments.

From the above, in the first and second embodiments of the present invention, the length of the optical fiber connector 14 is 12 [m] or 9 [m], which is shorter than the length 20 [m] of the amplifying fiber in Comparative Example 1, so that stimulated Raman scattering can be prevented. Further, in the first and second embodiments of the present invention, even if the length of the optical fiber connector 14 is short, the excitation light can be sufficiently absorbed, so that the efficiency of the fiber laser devices 1 and 2 is not reduced. Further, in the first and second embodiments of the present invention, the maximum value of the amount of generated heat per unit length of the optical fiber connector 14 can be reduced to about 50 [W/m]. As described above, in the first and second embodiments of the present invention, the length of the amplifying fiber can be shortened while reducing the heat generated by the amplifying fiber.

Although the embodiments of the present invention have been described above, the present invention is not limited to the above embodiments and can be freely changed within the scope of the present invention. For example, in the above-described first to third embodiments, when the absorption amount of excitation light per unit length of the amplifying fibers 14a to 14d is changed by the method shown in FIG. 2B, the addition area of the active element in the core 20 is changed by making the concentration of the active element in the addition region 20a the same. However, the addition area of the active element in the core 20 is changed, and the concentration of the active element in the addition region 20a is changed, so that the absorption amount of excitation light per unit length of the amplifying fibers 14a to 14d may be changed.

Further, although the fiber laser devices 1 to 3 of the above-described embodiments have one output end 17, an optical fiber or the like may be further connected to the tip of the output end 17. Further, a beam combiner may be connected to the tip of the output end 17 so as to bundle laser light from a plurality of laser devices.

Further, the fiber laser devices of the first and second embodiments described above are a so-called forward excitation-type fiber laser device, and the fiber laser device of the third embodiments described above is a so-called bidirectional excitation-type fiber laser device. However, the fiber laser device may be a so-called backward excitation-type fiber laser device in which the excitation light source 11 and the combiner 12 included in the fiber laser device 3 (see FIG. 4) of the third embodiments are omitted.

Further, the optical fiber connector 14 provided in the fiber laser devices 1 to 3 of the above-described embodiments may be adopted for the fiber laser device of a Master Oscillator Power Amplifier (MOPA) type. For example, in the case of a fiber laser device that amplifies the laser light output from a master oscillator by a preamplifier and a main amplifier, the above-described optical fiber connector 14 can be used as the amplifying fiber used in the preamplifier and the main amplifier.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 to 3: Fiber laser device
11: Excitation light source
12: Combiner
13: Resonator fiber
13a: HR-FBG
14: Optical fiber connector
14a to 14d: Amplifying fiber
15: Resonator fiber
15a: OC-FBG
17: Output end
18: Excitation light source
19: Combiner
20: Core

1. An optical fiber connector comprising:
amplifying fibers in which an active element activated by excitation light is added to a core of each of the amplifying fibers, wherein
the amplifying fibers are connected together such that an absorption amount of excitation light per unit length increases with an increase of a distance from an incident end of the excitation light, and
a mode field diameter of laser light propagating through the core is same among the amplifying fibers.

2. The optical fiber connector according to claim 1, wherein
the amplifying fibers each include a cladding that surrounds the core, and
the amplifying fibers are connected together such that an amount of the active element per unit volume of a fiber composed of the core and the cladding increases sequentially with the increase of the distance.

3. The optical fiber connector according to claim 1, wherein the amplifying fibers are connected together such that a concentration of the active element in the core gradually increases with the increase of the distance.

4. The optical fiber connector according to claim 1, wherein the amplifying fibers are connected together such that an addition area of the active element in the core increases sequentially with the increase of the distance.

5. The optical fiber connector according to claim 1, wherein the core of each of the amplifying fibers has a same diameter.

6. The optical fiber connector according to claim 1, wherein
the amplifying fibers comprise:
a first amplifying fiber; and
a second amplifying fiber,
the excitation light is incident on a first end of the first amplifying fiber,
an absorption amount of the excitation light per unit length of the first amplifying fiber is a first absorption amount,
a first end of the second amplifying fiber is connected to a second end of the first amplifying fiber, and
an absorption amount of the excitation light per unit length of the second amplifying fiber is a second absorption amount larger than the first absorption amount.

7. The optical fiber connector according to claim 6, wherein
the amplifying fibers further comprise a third amplifying fiber,
one end of the third amplifying fiber is connected to a second end of the second amplifying fiber, and
an absorption amount of the excitation light per unit length of the third amplifying fiber is a third absorption amount larger than the second absorption amount.

8. The optical fiber connector according to claim 6, wherein
the amplifying fibers further comprise a third amplifying fiber,
a first end of the third amplifying fiber is connected to a second end of the second amplifying fiber,
an absorption amount of the excitation light per unit length of the third amplifying fiber is a third absorption amount smaller than the second absorption amount, and
the excitation light is incident on a second end of the third amplifying fiber.

9. The optical fiber connector according to claim 8, wherein the third absorption amount is larger than the first absorption amount.

10. A fiber laser device comprising:
the optical fiber connector according to claim 1;
an excitation light source that outputs the excitation light;
a combiner that couples the excitation light to the optical fiber connector; and
an output end that outputs light amplified by the optical fiber connector to an outside of the fiber laser device.

11. The fiber laser device according to claim 10, wherein
FBG-formed (Fiber Bragg Grating-formed) resonator fibers are connected to both ends of the optical fiber connector, and
the combiner couples the excitation light to the optical fiber connector via one of the FBG-formed resonator fibers.

12. A fiber laser device comprising:
a first excitation light source that outputs first excitation light;
a second excitation light source that outputs second excitation light;
optical fiber connector according to claim 8;
FBG-formed resonator fibers connected to both ends of the optical fiber connector;
a first combiner that couples the first excitation light to the optical fiber connector via a first one of the FBG-formed resonator fibers;
a second combiner that couples the second excitation light to the optical fiber connector via a second one of the FBG-formed resonator fibers; and
an output end configured to output light amplified by the optical fiber connector to an outside of the fiber laser device.
